(19) United States
(12) Patent Application Publication
(10) Pub. No.: US 2025/0139987 A1
(43) Pub. Date: May 1, 2025

(54) APPARATUS AND METHOD FOR GENERATING THREE-DIMENSIONAL MAP DATA

(71) Applicant: HYUNDAI AUTOEVER CORP., Seoul (KR)

(72) Inventor: JungYoon Heo, Seoul (KR)

(73) Assignee: HYUNDAI AUTOEVER CORP., Seoul (KR)

(21) Appl. No.: 18/927,294

(22) Filed: Oct. 25, 2024

(30) Foreign Application Priority Data
Nov. 1, 2023 (KR) 10-2023-0149506

(51) Int. Cl. G06V 20/58; G01C 21/00; G06T 17/05; G06V 10/764; G06V 10/94

(52) U.S. Cl. CPC G06V 20/58; G01C 21/3822; G06T 17/05; G06V 10/764; G06V 10/95

(57) ABSTRACT

An apparatus for generating three-dimensional map data includes a communication interface and a processor connected to the communication interface. The processor collects sensor data related to surrounding objects from a vehicle by means of the communication interface, classifies the collected sensor data for each object, stores the sensor data classified for each object, generates three-dimensional modeling data and position data for each object based on the sensor data classified for each object, and generates three-dimensional map data for navigation based on the three-dimensional modeling data and the position data generated for each object.

### CROSS-REFERENCE TO RELATED APPLICATION

This application claims the benefit of and priority to Korean Patent Application No. 10-2023-0149506, filed on Nov. 1, 2023, the entire contents of which are hereby incorporated herein by reference.

### TECHNICAL FIELD

The present disclosure relates to an apparatus and method for generating three-dimensional map data.

### BACKGROUND

A route-finding device, such as a navigation system, uses a current position of a vehicle and map information to find a route to a destination. The route-finding device should always have up-to-date map information to perform route guidance to a destination. To this end, the map information provided to the route-finding device may be periodically updated.

In the related art, information about roads and facilities is collected by a vehicle equipped with a separate data collection system (e.g., a mobile mapping system), and the map information is created or updated by processing the collected information by professional experts. However, there is a problem in that the method in the related art requires a significant amount of time and costs to create or update the map information.

The discussions in this Background section are intended merely to provide background information and do not constitute an admission of prior art.

### SUMMARY

Various embodiments provide an apparatus and method for generating three-dimensional map data that are capable of generating three-dimensional map data for navigation from sensor data collected from a vehicle.

In an embodiment, an apparatus for generating three-dimensional map data is provided. The apparatus includes a communication interface and a processor connected to the communication interface. The processor is configured to collect sensor data related to surrounding objects from a vehicle by means of the communication interface. The processor is also configured to classify the sensor data for each object, store the sensor data, and generate three-dimensional modeling data and position data for each object on the basis of the sensor data classified for each object and stored. The processor is further configured to and generate three-dimensional map data for navigation on the basis of the three-dimensional modeling data and the position data for each object.

In an aspect, the sensor data may be data detected by at least one of a camera, a lidar, a radar, or an ultrasonic sensor provided in the vehicle.

In an aspect, the processor may be configured to estimate a shape of the object by using the sensor data and generate the three-dimensional modeling data on the basis of the estimated shape.

In an aspect, the processor may be configured to, when cross-section modeling data corresponding to the shape of the object are stored in advance (or pre-stored), generate the three-dimensional modeling data by using the cross-section modeling data corresponding to the shape of the object.

In an aspect, the processor may be configured to generate the three-dimensional modeling data by spacing cross-sections determined by the cross-section modeling data and performing modeling on the object by triangulating the spaced cross-sections.

In an aspect, the processor may be configured to, when cross-section modeling data corresponding to the shape of the object are not stored in advance (or not pre-stored), estimate the cross-section modeling data of the object on the basis of the sensor data and generate the three-dimensional modeling data by using the estimated cross-section modeling data.

In an aspect, the processor may be configured to generate the three-dimensional map data by performing, for each object, a process of disposing an object model, which is determined by the three-dimensional modeling data, at a position determined by the position data.

In an aspect, the apparatus may be implemented as a server or a cloud computing system.

In an embodiment, a method of generating three-dimensional map data is provided. The method includes collecting sensor data related to surrounding objects from a vehicle. The method also includes classifying the sensor data for each object and storing the sensor data. The method additionally includes generating three-dimensional modeling data for each object on the basis of the sensor data classified for each object and stored. The method further includes generating position data for each object on the basis of the sensor data classified for each object and stored. The method also includes generating three-dimensional map data for navigation on the basis of the three-dimensional modeling data and the position data for each object.

In an embodiment, an apparatus for generating three-dimensional map data is provided. The apparatus includes a communication interface configured to receive, from a vehicle, position data and sensor data related to surrounding objects detected by at least one sensor. The apparatus also includes a processor configured to generate three-dimensional modeling data for each object on the basis of the received sensor data. The apparatus additionally includes a memory configured to store the three-dimensional modeling data and the position data for each object. The processor is configured to generate three-dimensional map data on the basis of the three-dimensional modeling data and the position data for each object.

According to one aspect of the present disclosure, a general vehicle may be used instead of a vehicle equipped with the mobile mapping system (MMS) during the process of collecting data for generating the three-dimensional map data, thereby reducing time and costs required to generate the three-dimensional map data.

According to one aspect of the present disclosure, the process of generating the three-dimensional map data for navigation from sensor data collected from the vehicle may be automated, thereby more quickly generating the three-dimensional map data for navigation.

The effects of the present disclosure are not limited to the aforementioned effects. Other effects, that are not mentioned herein, should be clearly understood by those having ordinary skill in the art from the following description.

### BRIEF DESCRIPTION OF THE DRAWINGS

FIG. 1 is a conceptual view illustrating a system for generating three-dimensional map data according to an embodiment of the present disclosure.

FIG. 2 is a block configuration view illustrating an apparatus for generating three-dimensional map data according to an embodiment of the present disclosure.

FIG. 3 is a block configuration view illustrating a processor according to an embodiment of the present disclosure.

FIGS. 4 and 5 are views for explaining a process of generating three-dimensional modeling data according to an embodiment of the present disclosure.

FIG. 6 is a flowchart illustrating a method of generating three-dimensional map data according to an embodiment of the present disclosure.

### DETAILED DESCRIPTION

The components described herein may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described herein may be implemented by software, and the software may be recorded on a recording medium. The components, the functions, and the processes described herein may be implemented by a combination of hardware and software.

The methods according to embodiments of the present disclosure may be embodied as a program that is executable by a computer or a processor, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor receives instructions and data from a read-only memory or a random access memory or both. Elements of a computer may include at least one processor to execute instructions and one or more memory devices to store instructions and data. Generally, a computer also includes or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor also may access, store, manipulate, process, and create data in response to execution of the software. For purpose of simplicity, the description of a processor device is used as singular; however, one having ordinary skill in the art should be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present disclosure includes details of a number of specific implements, but it should be understood that the details do not limit the scope of the present disclosure but rather describe features of the example embodiment. Features described in the present disclosure in the context of individual embodiments may be implemented as a combination in a single example embodiment. Further, various features described in the present disclosure in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should be understood that the operations do not necessarily need to be performed in the specific order or in sequence to obtain desired results or that all the operations need to be performed. In some examples, multitasking and parallel processing may be advantageous. In addition, it should be understood that a separation of various apparatus components described herein does not necessarily need to be present in all embodiments. I For example, it should be understood that the above-described program components and apparatuses may be incorporated into a single software product or may be packaged in multiple software products.

It should be understood that the embodiments disclosed herein are merely illustrative and are not intended to limit the scope of the present disclosure. It should be apparent to one of ordinary skill in the art that various modifications of the embodiments may be made without departing from the spirit and scope of the appended claims and their equivalents.

Hereinafter, with reference to the accompanying drawings, embodiments of the present disclosure are described in detail to enable a person having ordinary skill in the art to readily carry out the present disclosure. However, the present disclosure may be embodied in many different forms and is not limited to the embodiments described herein.

In the following description of the embodiments of the present disclosure, a detailed description of known functions and configurations incorporated herein has been omitted where it was determined that the detailed description may obscure the subject matter of the present disclosure. Further, parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. For example, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

In the present disclosure, when a component is referred to as being “linked,” “coupled,” or “connected” to another component, it should be understood that not only a direct connection relationship but also an indirect connection relationship through one or more intermediate components may also be included. In addition, when a component is referred to as “comprising,” “including,” or “having” another component, it may mean further inclusion of another component not the exclusion thereof, unless explicitly described to the contrary.

When a component, device, module, element, or the like of the present disclosure is described as having a purpose or performing an operation, function, or the like, the component, device, or element should be considered herein as being “configured to” meet that purpose or perform that operation or function.

In the present disclosure, the terms first, second, etc. are used only for the purpose of distinguishing one component from another, and do not limit the order or importance of components, etc., unless specifically stated otherwise. Thus, within the scope of this disclosure, a first component in one embodiment may be referred to as a second component in an embodiment. Similarly a second component in one embodiment may be referred to as a first component in an embodiment.

Hereinafter, an apparatus and method for generating three-dimensional map data are described in detail with reference to the accompanying drawings through various example embodiments.

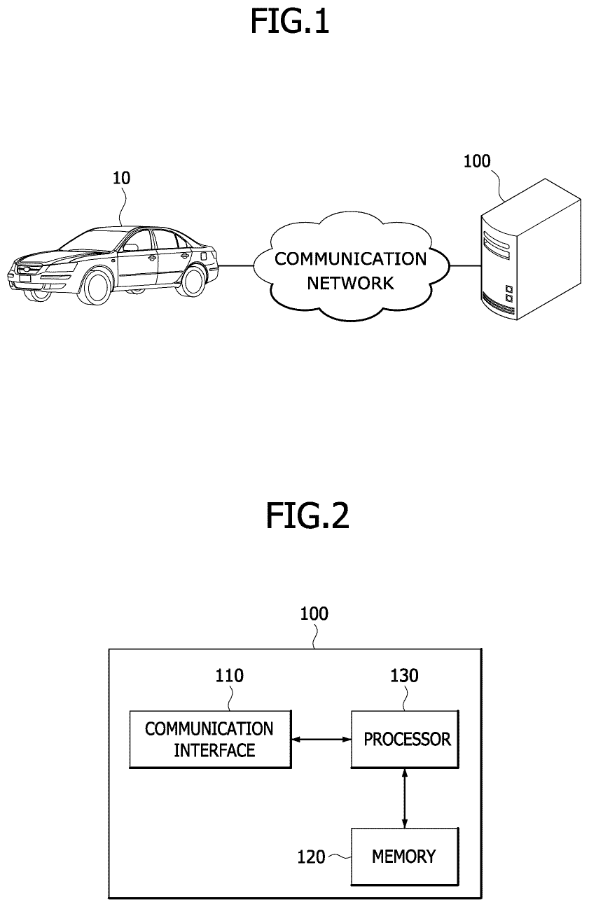

FIG. 1 is a conceptual view illustrating a system for generating three-dimensional map data according to an embodiment of the present disclosure.

With reference to FIG. 1, the system for generating three-dimensional map data according to the embodiment of the present disclosure may include at least one vehicle 10, and an apparatus 100 for generating three-dimensional map data (hereinafter, referred to as a ‘map data generation apparatus’). The system for generating three-dimensional map data according to the embodiment of the present disclosure may further include various constituent elements in addition to constituent elements illustrated in FIG. 1.

The vehicle 10 may be an apparatus for collecting data required to generate three-dimensional map data for navigation. The vehicle 10 may be a general vehicle other than a vehicle equipped with a separate data collection system (e.g., a mobile mapping system). The vehicle 10 may include sensors for detecting data related to surrounding objects (surrounding environments). For example, the vehicle 10 may include at least one of a camera, a lidar, a radar, and/or an ultrasonic sensor. However, the type of sensor included in the vehicle 10 is not limited to the above-mentioned sensors. The vehicle 10 may include various types of sensors for detecting information about the surrounding objects.

Sensor data related to the surrounding objects (surrounding environments) may be detected by at least one of the sensors mounted in the vehicle 10. The surrounding objects may include roads, facilities, and/or buildings, for example. However, the present disclosure is not limited thereto. The surrounding objects may include various objects capable of being reflected to three-dimensional map data.

The vehicle 10 may transmit sensor data, detected by at least one of the mounted sensors, to the map data generation apparatus 100. The generation apparatus 100, according to an embodiment, is described in more detail below. The vehicle 10 may include communication equipment for performing wireless communication. The vehicle 10 may transmit sensor data to the map data generation apparatus 100 by means of the communication equipment. The vehicle 10 may include a GPS and may transmit position data detected by the GPS along with the sensor data to the map data generation apparatus 100.

The map data generation apparatus 100 may be an apparatus for generating three-dimensional map data for navigation. The map data generation apparatus 100 may be a type of server. For example, the map data generation apparatus 100 may be provided in the form of a cloud server or a cloud computing system. The map data generation apparatus 100 may receive sensor data transmitted from the vehicle 10 and may generate three-dimensional map data from the received sensor data.

The map data generation apparatus 100 may classify and store sensor data transmitted from the vehicle 10, for each object. The map data generation apparatus 100 may also generate three-dimensional modeling data and position data for each object based on the sensor data classified and stored for each object. The map data generation apparatus 100 may further generate three-dimensional map data based on the three-dimensional modeling data and the position data for each object. The three-dimensional modeling data may be data for modeling the object in a three-dimensional manner and include information on the shape of the object. The three-dimensional map data may be data related to a map implemented in a three-dimensional manner and may include information on shapes and positions of various objects required to guide traveling of the vehicle 10.

The map data generation apparatus 100 may store in advance (or pre-store) an algorithm for converting the sensor data into three-dimensional modeling data and an algorithm for generating three-dimensional map data from the three-dimensional modeling data for each object. The map data generation apparatus 100 may generate three-dimensional map data from sensor data by using the algorithm stored in advance (or pre-stored).

In the example described above, a single apparatus performs the process of classifying and storing the sensor data for each object and the process of generating the three-dimensional map data on the basis of the sensor data classified and stored for each object. However, the system may be configured such that the above-mentioned processes are performed by different apparatuses.

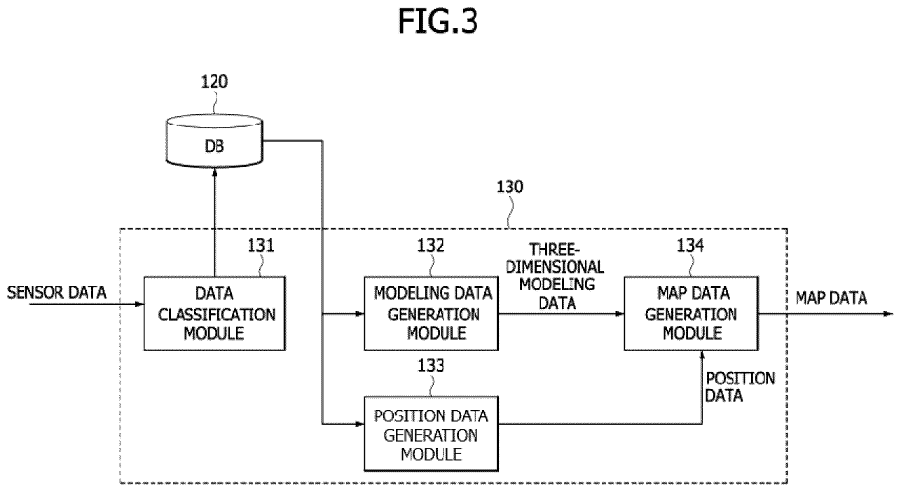

FIG. 2 is a block configuration view illustrating an apparatus for generating three-dimensional map data according to an embodiment of the present disclosure.

With reference to FIG. 2, the apparatus 100 for generating three-dimensional map data according to the embodiment of the present disclosure may include a communication interface 110, a memory 120, and a processor 130. The constituent elements included in the apparatus 100 for generating three-dimensional map data according to the embodiment of the present disclosure may be connected through a common bus or connected through a separate interface or a separate bus based on the processor 130. The apparatus 100 for generating three-dimensional map data may further include various constituent elements in addition to the constituent elements illustrated in FIG. 2, or some constituent elements among the above-mentioned constituent elements may be excluded.

The communication interface 110 may communicate with an external device. For example, the communication interface 110 may communicate with the vehicle 10 and may receive, from the vehicle 10, information (e.g., sensor data) required to generate a three-dimensional map for navigation. The communication interface 110 may output a result, calculated by the processor 130 as described in more detail below, to the external device. For example, the communication interface 110 may output the three-dimensional map data, generated by the processor 130, to the external device. The communication interface 110 may communicate with the external device using various types of communication methods.

The memory 120 may store various types of information required for operation of the processor 130. The memory 120 may correspond to a database. For example, the memory 120 may store in advance (or pre-store) the algorithm for converting the sensor data into the three-dimensional modeling data by the processor 130 and the algorithm for generating the three-dimensional map data from the three-dimensional modeling data for each object. In addition, the memory 120 may store in advance (or pre-store) cross-section modeling data for each shape of each of various objects. The cross-section modeling data may be data for modeling the object and include information on a cross-sectional shape of the object. The memory 120 may also store various types of information calculated during operation of the processor 130.

The processor 130 may be operatively connected to the communication interface 110 and the memory 120. The processor 130 may also be implemented as a central processing unit (CPU), a micro-controller unit (MCU), or a system-on-chip (SoC). The processor 130 may be configured to control a plurality of hardware or software constituent elements connected to the processor 130, process and compute various types of data, execute at least one instruction stored in the memory 120, and store data of execution results in the memory 120 by operating an operating system or an application.

The processor 130 may collect the sensor data related to the surrounding objects from the vehicle 10 through the communication interface 110, may classify the collected sensor data for each object, and store the sensor data in the memory 120. The processor 130 may generate the three-dimensional modeling data and the position data for each object based on the sensor data classified for each object and stored in the memory 120, and may generate the three-dimensional map data for navigation on the basis of the three-dimensional modeling data and the position data generated for each object. Accordingly, the processor 130 may generate the three-dimensional map data for navigation by generating a three-dimensional model for each of the surrounding objects of the vehicle 10 on the basis of the sensor data collected from the vehicle 10.

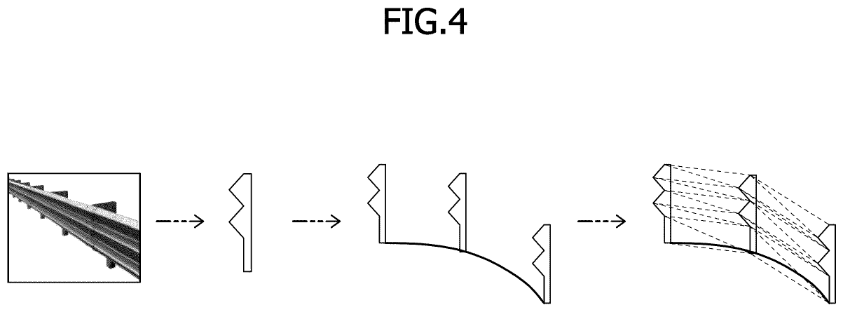

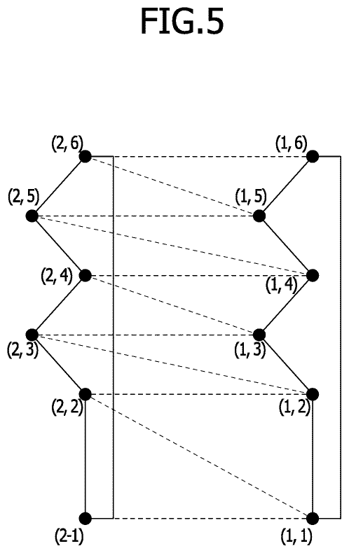

FIG. 3 is a block configuration view illustrating a processor according to an embodiment of the present disclosure. FIGS. 4 and 5 are views for explaining a process of generating three-dimensional modeling data according to an embodiment of the present disclosure.

With reference to FIG. 3, the processor 130 according to the embodiment of the present disclosure may include a data classification module 131, a modeling data generation module 132, a position data generation module 133, and a map data generation module 134. As used herein, “module” may be a constituent element that performs some of the functions of the processor 130 classified depending on the functions. The operation performed by each of the modules may be understood as the operation performed by the processor 130.

The data classification module 131 may classify the sensor data, collected from the vehicle 10, for each object and may store the sensor data in the memory 120. The data classification module 131 may identify the object related to the corresponding sensor data collectively in consideration of the time at which the sensor data are generated, the position of the vehicle 10 (e.g., the position data of the vehicle 10 detected by the GPS) at the time at which the sensor data are generated, the contents of the sensor data, and/or the like. The data classification module 131 may classify the sensor data in accordance with the identified object and may store the sensor data in the memory 120. For example, in the case of classifying sensor data collected from the vehicle 10 traveling on a roadway on which guard rails and streetlights are installed, the data classification module 131 may classify the sensor data into data related to the roadway (including lanes), data related to the guard rails, and data related to the streetlights and may store the data in the memory 120.

The modeling data generation module 132 may generate the three-dimensional modeling data for each object on the basis of the sensor data classified for each object and stored in the memory 120. The modeling data generation module 132 may generate the three-dimensional modeling data for each object by performing, for each object, a process of estimating a shape of the object by using the sensor data and generating the three-dimensional modeling data for the object on the basis of the estimated shape.

The modeling data generation module 132 may determine whether the cross-section modeling data corresponding to the shape of the object are stored in advance (or pre-stored) in the memory 120. In case that the cross-section modeling data corresponding to the shape are stored in advance (or pre-stored) in the memory 120, the modeling data generation module 132 may generate the three-dimensional modeling data for the corresponding object by using the cross-section modeling data corresponding to the shape.

The cross-section modeling data for each shape may be stored in advance (or pre-stored) for each object in the memory 120. The modeling data generation module 132 may obtain the cross-section modeling data, that correspond to the shape of the object, from the memory 120 and may generate the three-dimensional modeling data for the corresponding object by using the obtained cross-section modeling data. The modeling data generation module 132 may identify the cross-section modeling data, that correspond to the shape of the object, by comparing a shape and size of an outer peripheral line of the object determined by the shape of the object and a shape and size of an outer peripheral line of the cross-section modeling data stored in the memory 120.

The modeling data generation module 132 may generate the three-dimensional modeling data for the object by performing modeling on the object by spacing the cross-sections determined by the cross-section modeling data and triangulating the spaced cross-sections. In an example, the modeling data generation module 132 may generate the three-dimensional modeling data on the object by means of the modeling process of spacing the cross-sections corresponding to the shape of the object and connecting the outer peripheral lines of the spaced cross-sections on the basis of a preset rule. An arrangement interval between the cross-sections may be set in advance (or pre-set), and the modeling data generation module 132 may determine the number and positions of cross-sections to be disposed in consideration of the shape of the object.

For example, assuming that three-dimensional modeling data related to the guard rail are generated, the modeling data generation module 132, as illustrated in FIG. 4, may generate the three-dimensional modeling data for the guard rail by means of the modeling process of detecting the cross-sections, that correspond to the shape of the guard rail estimated from the sensor data, from the memory 120, spacing the detected cross-sections at predetermined intervals, and connecting the outer peripheral lines of the spaced cross-sections on the basis of the preset rule.

In this case, the modeling data generation module 132 may connect vertices of the guard rail on the basis of the preset rule. The modeling data generation module 132 may impart coordinates to the vertices in accordance with the cross-section, which includes the vertices, and the positions of the vertices on the cross-section, and may connect the vertices positioned on the coordinate of (n, n) to the vertices positioned on the coordinates of (n+1, n) and (n+1, n+1). For example, assuming that a first cross-section and a second cross-section are present, the modeling data generation module 132, as illustrated in FIG. 5, may connect the vertices positioned on the coordinate of (1, 1) to the vertices positioned on the coordinates of (2, 1) and (2, 2) and connect the vertex positioned on the coordinate of (1, 2) to the vertices positioned on the coordinates of (2, 2) and (2, 3).

In case that the cross-section modeling data corresponding to the shape of the object are not stored in advance (or not pre-stored) in the memory 120, the modeling data generation module 132 may estimate the cross-section modeling data of the object on the basis of the sensor data and may generate the three-dimensional modeling data for the object by using the estimated cross-section modeling) data. For example, in case that the cross-section modeling data corresponding to the shape of the object are not stored in advance (or not pre-stored) in the memory 120, the modeling data generation module 132 may generate the three-dimensional modeling data for the object by estimating the cross-sectional shape of the object from the sensor data, spacing the cross-sections of the estimated shape, and performing modeling on the object by triangulating the spaced cross-sections.

For example, assuming that three-dimensional modeling data related to the guard rail are generated, the modeling data generation module 132 may generate the three-dimensional modeling data for the guard rail by means of the modeling process of estimating the shape of the cross-section of the guard rail from the sensor data, spacing the cross-sections according to the estimated shape at predetermined intervals, and connecting the outer peripheral lines of the spaced cross-sections on the basis of the preset rule.

In an example, the process of generating the three-dimensional modeling data by using the cross-section modeling data may be performed only in the structure, like the guard rail, in which identical structures extend in a particular direction while being repeated. In case that a structure is not the structure in which the identical structures extend in the particular direction while being repeated, the modeling data generation module 132 may obtain the three-dimensional modeling data corresponding to the object from the memory 120 and may use the obtained three-dimensional modeling data as the three-dimensional modeling data of the corresponding object. The memory 120 may store in advance (or pre-store) the three-dimensional modeling data for particular objects (the objects that do not have the structure in which the identical structures extend in the particular direction while being repeated). The modeling data generation module 132 may use the three-dimensional modeling data, that are stored in advance (or pre-stored), without separately generating the three-dimensional modeling data for the object that does not have the structure in which the identical structures extend in the particular direction while being repeated.

For example, in the case of a signal lamp, the modeling data generation module 132 may obtain three-dimensional modeling data, that correspond to the signal lamp, from the memory 120 and may use the detected three-dimensional modeling data as the three-dimensional modeling data for the signal lamp in an intact manner.

The position data generation module 133 may generate the position data for each object on the basis of the sensor data classified for each object and stored in the memory 120. The position data generation module 133 may generate the position data of the object collectively based on the position of the vehicle 10 at the time at which the sensor data are generated, the contents of the sensor data, and/or the like.

The map data generation module 134 may generate the three-dimensional map data for navigation on the basis of the three-dimensional modeling data and the position data for each object. The map data generation module 134 may generate the three-dimensional map data by performing, for each object, the process of disposing an object model, determined by the three-dimensional modeling data, at a position determined by the position data.

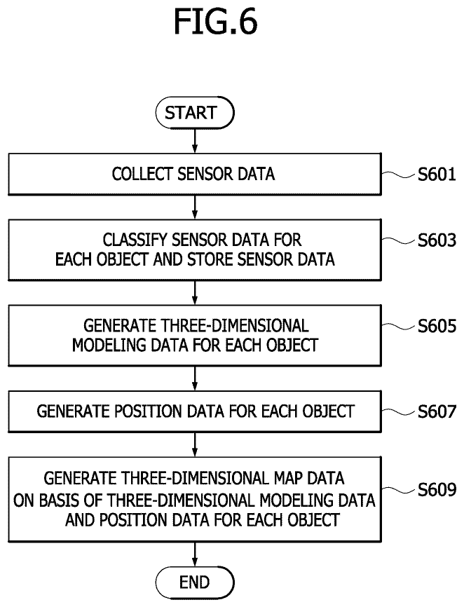

FIG. 6 is a flowchart illustrating a method of generating three-dimensional map data according to an embodiment of the present disclosure.

Hereinafter, the method of generating three-dimensional map data according to an embodiment of the present disclosure is described with reference to FIG. 6. Among the processes described below, some processes may be omitted or may be performed in an order different from the order of the processes described below.

In an operation S601, the processor 130 may collect the sensor data related to the surrounding object from the vehicle 10 by means of the communication interface 110.

In an operation S603, the processor 130 may classify the sensor data for each object and store the sensor data in the memory 120. The processor 130 may identify the time at which the sensor data are generated, and the object related to the corresponding sensor data collectively based on the position of the vehicle 10, the contents of the sensor data, and/or the like at the time at which the sensor data are generated. The processor 130 may classify the sensor data in accordance with the identified object and may store the sensor data in the memory 120.

In an operation S605, the processor 130 may generate the three-dimensional modeling data for each object on the basis of the sensor data classified for each object and stored in the memory 120. The processor 130 may estimate the shape of the object by using the sensor data and may generate the three-dimensional modeling data for the object on the basis of the estimated shape.

In an operation S607, the processor 130 may generate the position data for each object on the basis of the sensor data classified for each object and stored in the memory 120. The processor 130 may generate the position data of the object collectively based on the position of the vehicle 10, the contents of the sensor data, and/or the like at the time at which the sensor data are generated.

In an operation S609, the processor 130 may generate the three-dimensional map data for navigation on the basis of the three-dimensional modeling data and the position data for each object. The processor 130 may generate the three-dimensional map data by performing, for each object, the process of disposing the object model, determined by the three-dimensional modeling data, at the position determined by the position data.

As described above, the apparatus and method for generating three-dimensional map data according to embodiments of the present disclosure use a general vehicle instead of a vehicle equipped with a mobile mapping system (MMS) during the process of collecting data for generating the three-dimensional map data, thereby reducing time and costs required to generate the three-dimensional map data. In addition, the apparatus and method for generating three-dimensional map data according to embodiments of the present disclosure automate the process of generating the three-dimensional map data for navigation from the sensor data collected from the vehicle, thereby more quickly generating the three-dimensional map data for navigation.

Although some embodiments of the disclosure have been described herein for illustrative purposes, those having ordinary skill in the art should appreciate that various modifications, additions, and substitutions are possible, without departing from the scope and spirit of the present disclosure as defined in the appended claims. Thus, the true technical scope of the disclosure should be defined by the appended claims and their equivalents.

What is claimed is:

1. An apparatus for generating three-dimensional map data, the apparatus comprising:
a communication interface; and
a processor connected to the communication interface,
wherein the processor is configured to
collect sensor data related to surrounding objects from a vehicle by means of the communication interface,
classify the sensor data for each object,
store the sensor data classified for each object,
generate three-dimensional modeling data and position data for each object based on the sensor data classified for each object, and
generate three-dimensional map data for navigation based on the three-dimensional modeling data and the position data for each object.

2. The apparatus of claim 1, wherein the sensor data are data detected by at least one of a camera, a lidar, a radar, or an ultrasonic sensor provided in the vehicle.

3. The apparatus of claim 1, wherein the processor is configured to, for an object among the objects:
estimate a shape of the object by using the sensor data; and
generate the three-dimensional modeling data based on the estimated shape.

4. The apparatus of claim 3, wherein the processor is configured to, when cross-section modeling data corresponding to the shape of the object are pre-stored, generate the three-dimensional modeling data by using the cross-section modeling data, corresponding to the shape of the object, that is pre-stored.

5. The apparatus of claim 4, wherein the processor is configured to generate the three-dimensional modeling data by spacing cross-sections determined by the cross-section modeling data and performing modeling on the object by triangulating the spaced cross-sections.

6. The apparatus of claim 4, wherein the processor is configured to, when cross-section modeling data corresponding to the shape of the object are not pre-stored, estimate the cross-section modeling data of the object based on the sensor data and generate the three-dimensional modeling data by using the estimated cross-section modeling data.

7. The apparatus of claim 1, wherein the processor is configured to generate the three-dimensional map data by performing, for each object, a process of disposing an object model, determined by the three-dimensional modeling data, at a position determined by the position data.

8. The apparatus of claim 1, wherein the communication interface and the processor are provided as a server or a cloud computing system.

9. A method of generating three-dimensional map data, performed by a computing device including a processor, the method comprising:
collecting sensor data related to surrounding objects from a vehicle;
classifying the sensor data for each object;
storing the sensor data classified for each object;
generating three-dimensional modeling data for each object based on the sensor data classified for each object;
generating position data for each object based on the sensor data classified for each object; and
generating three-dimensional map data for navigation based on the three-dimensional modeling data and the position data for each object.

10. The method of claim 9, wherein the sensor data are data detected by at least one of a camera, a lidar, a radar, or an ultrasonic sensor provided in the vehicle.

11. The method of claim 9, wherein generating the three-dimensional modeling data for each object includes:
estimating a shape of the object by using the sensor data; and
generating the three-dimensional modeling data based on the estimated shape.

12. The method of claim 11, wherein generating the three-dimensional modeling data for each object includes, when cross-section modeling data corresponding to the shape of the object are pre-stored in a memory, generating the three-dimensional modeling data by using the cross-section modeling data corresponding to the shape of the object obtained from the memory.

13. The method of claim 12, wherein generating the three-dimensional modeling data for each object includes generating the three-dimensional modeling data by spacing cross-sections determined by the cross-section modeling data and performing modeling on the object by triangulating the spaced cross-sections.

14. The method of claim 12, wherein generating the three-dimensional modeling data for each object includes, when cross-section modeling data corresponding to the shape of the object are not pre-stored, estimating the cross-section modeling data on the object based on the sensor data and generating the three-dimensional modeling data by using the estimated cross-section modeling data.

15. The method of claim 9, wherein generating the three-dimensional map data includes performing, for each object, a process of disposing an object model, determined by the three-dimensional modeling data, at a position determined by the position data.

16. The method of claim 9, wherein the computing device is implemented as a server or a cloud computing system.

17. An apparatus for generating three-dimensional map data, the apparatus comprising:
a communication interface configured to receive, from a vehicle, position data and sensor data related to surrounding objects detected by at least one sensor;
a processor configured to generate three-dimensional modeling data for each object based on the sensor data; and
a memory configured to store the three-dimensional modeling data and the position data for each object,
wherein the processor is configured to generate three-dimensional map data based on the three-dimensional modeling data and the position data for each object.

18. The apparatus of claim 17, wherein the processor is configured to generate the three-dimensional modeling data for each object by estimating a shape of the object based on the sensor data and obtaining cross-section modeling data, that correspond to the shape of the object, from the memory.

19. The apparatus of claim 18, wherein the processor is configured to generate the three-dimensional modeling data by spacing cross-sections determined by the cross-section modeling data and performing modeling on the object by triangulating the spaced cross-sections.

20. The apparatus of claim 17, wherein the communication interface, the processor, and the memory are provided as a server or a cloud computing system.
